(19) United States
(12) Patent Application Publication
(10) Pub. No.: US 2005/0039481 A1
(43) Pub. Date: Feb. 24, 2005

(54) Rotor desiccant air-conditioning system for a motor vehicle

(76) Inventor: Eileen Chant, Highland Park, NJ (US)

Correspondence Address: Eileen Chant, 225 Magnolia Street, Highland Park, NJ, 08904, US

(21) Appl. No.: 10/645,171

(22) Filed: Aug. 21, 2003

(51) Int. Cl. F25B 27/00; B60H 1/32; F25D 23/00

(52) U.S. Cl. 62/271; 62/238.3; 62/238.6; 62/244

(57) ABSTRACT

An air-conditioning system for a cabin of a motorized vehicle comprising of an evaporator and desiccant, where said desiccant is downstream of evaporator, and said desiccant is a rotor that uses nearby excess heat to regenerate the desiccant.

### BACKGROUND

This invention relates to dehumidification and cooling in an enclosed area, in particular, a method and system for climate control in a motorized vehicle.

### BACKGROUND OF THE INVENTION—DESCRIPTION OF PRIOR ART

This invention relates to dehumidification and cooling in an enclosed area, in particular, a method and system for climate control in a motorized vehicle. There exists a strong need for dehumidification in the enclosed area of a motor vehicle; for safety reasons, i.e. the windshield can fog up during high humidity conditions, resulting in reduced driver visibility; comfort of the passengers; and if the humidity of the cabin can be lowered by thermally activated means, the compressor power consumption and the size of the direct expansion (DX) air-conditioning system can be reduced. If the load on the DX system is reduced through addition of a light component (i.e. a small desiccant rotor), the benefits include; fuel savings, reduced shaft horsepower required to operate the compressor, and possibly weight reduction. With such potential benefits, a design study of such a system is warranted.

Different methods of systems to dehumidify and cool air in motor vehicles have been previously described. U.S. 2002/0002833 A1 describes an A/C system including an evaporator, a desiccant dryer (located downstream of the evaporator, and a compressor fluidly connected to the evaporator.) The desiccant dehumidifier in this system is of the carousel type. This patent explicitly states that the only sufficient heat source existing in a motorized vehicle for the regeneration of the desiccant is from the engine exhaust air, and states that this heat source is undesirable due to safety reasons. The safety concerns are founded: If the catalytic converter and the seals separating the process and regeneration air on the desiccant dryer were to simultaneously fail, the result would be unburned hydrocarbons and carbon monoxide entering the cabin. However, the statement that this is the only sufficient heat source is not true for U.S. 2002/0002833 A1 or for the present invention due to the configuration of these systems. The other sufficient sources of regeneration heat for systems of these configurations (desiccant dryer downstream of evaporator) are the engine coolant leaving the engine block (185-200 deg F.) and the hot air leaving the radiator (estimated to be approximately 130 deg F.). These sources of heat, while unacceptable for systems requiring regeneration temperatures in excess of 200 deg F. (where the desiccant dryer is upstream of the evaporator), are acceptable for U.S. 2002/0002833 A1 or for the present invention since the regeneration temperature requirements are estimated to be approximately 100-130 deg F.

U.S. 2002/0092419 A1 describes an air desiccant system for climate control in a motor vehicle. This system uses a vacuum method for desiccant regeneration. The desiccant dryer in this system is of the cartridge type. The only heat source that this patent mentions in a motorized vehicle for the regeneration of the desiccant is from the exhaust, and states that this heat source is undesirable. This patent overlooks the other sources of heat for desiccant regeneration, as previously stated. Furthermore, there are disadvantages to using a vacuum for the regeneration of the desiccant. They will be presented in the following paragraph.

In any desiccant system that uses low pressure regeneration air and ambient pressure process air, the seals that separate the process side from the regeneration side have to be very sturdy, well-mated to the dryer face and also wear resistant over time. If the seals don't have these characteristics then the potential exists for unacceptable amounts of higher ambient pressure air to leak into the low pressure regeneration side. In other words, there has to be an excellent seal mating or the desiccant performance will suffer adversely.

Another disadvantage of the vacuum from engine method is that such a system will require redesign of the engine's intake manifold in order to gain access to the required low pressure air.

U.S. Pat. No. 5,514,035 describes a desiccant based windshield defog system including an evaporator, a desiccant dryer (located upstream of the evaporator), and a compressor fluidly connected to the evaporator. The desiccant dryer in this proposed system is a rotor. This system is not optimized because the desiccant dryer is located upstream of the evaporator. A model was developed to simulate these systems and identify the optimum configuration. The results are shown in FIG. 1. FIG. 1 shows that the compressor power consumption reduction is overall larger and more uniform when the desiccant dryer is placed after the evaporating coil.

### BRIEF SUMMARY OF THE INVENTION

This invention presents a method and apparatus for dehumidification and cooling in an enclosed area. In particular, it is a method and system for climate control in a motorized vehicle. The air conditioning system includes an evaporator and desiccant dryer located downstream of the evaporator, and a compressor fluidly connected to the evaporator. The desiccant dryer in this system is of the rotor type, and the heat source used to regenerate the desiccant is the excess heat generated by the motor. The engine heat can be used to regenerate the desiccant by one of the following 3 methods:
1. Hot air coming off the radiator routed directly into the rotor housing (approx. 130 deg F.)
2. Engine coolant, exiting the engine block (approx 190 deg F.), routed to a liquid-to-air heat exchanger to heat the regeneration air.
3. Hot engine exhaust, after catalytic conversion, routed to an air-to-air heat exchanger.

The advantages of this system include:
1. As FIG. 1 shows, placing the desiccant rotor upstream of the evaporator will not necessarily reduce shaft power to the compressor. But for the present invention, electric energy requirements are uniformly displaced with “free” thermal energy requirements. Thus the cooling efficiency, measured by electric power consumption, is higher.
2. The present invention is simple, and reduces compressor power consumption and cooling load on the evaporator. Reduced cooling load on the evaporator means that compressor, condenser and evaporator coils will be smaller and lighter. Note that the desiccant rotor itself is very light, weighing on the order of two pounds. Some additional fan power to drive process and regeneration air through the desiccant dryer is required, but this amount is more than offset by the reduced power consumption of the compressor.
3. The temperature method of desiccant regeneration provides a simpler, less problematic solution to desiccant regeneration than the vacuum method: The sealing system will be less expensive and require little or no maintenance. In addition, upon failure, the system performance changes are expected to be small since the similar pressures on the process and regeneration side will result in minimal leakage rates.
4. In contrast with the systems where the desiccant rotor is upstream of the evaporator, there is sufficient excess heat produced in a motor vehicle for the present invention.
5. If the system is so designed, the additional dehumidification capability provided by the desiccant rotor will improve comfort to the passengers and the defog capacity of the air-conditioning system.

### BRIEF DESCRIPTION OF DRAWINGS

FIG. 2 depicts the preferred embodiment of the invention.

### REFERENCE NUMERALS IN DRAWINGS

11—Intake air (from cabin or ambient)
12—After filter and fan, entering evaporator coil
13—Leaving evaporator coil, entering desiccant rotor
14—Leaving evaporator coil (to cabin)
15—Regeneration air inlet
16—Regeneration air outlet
17—Discharge air

### DETAILED DESCRIPTION OF THE INVENTION

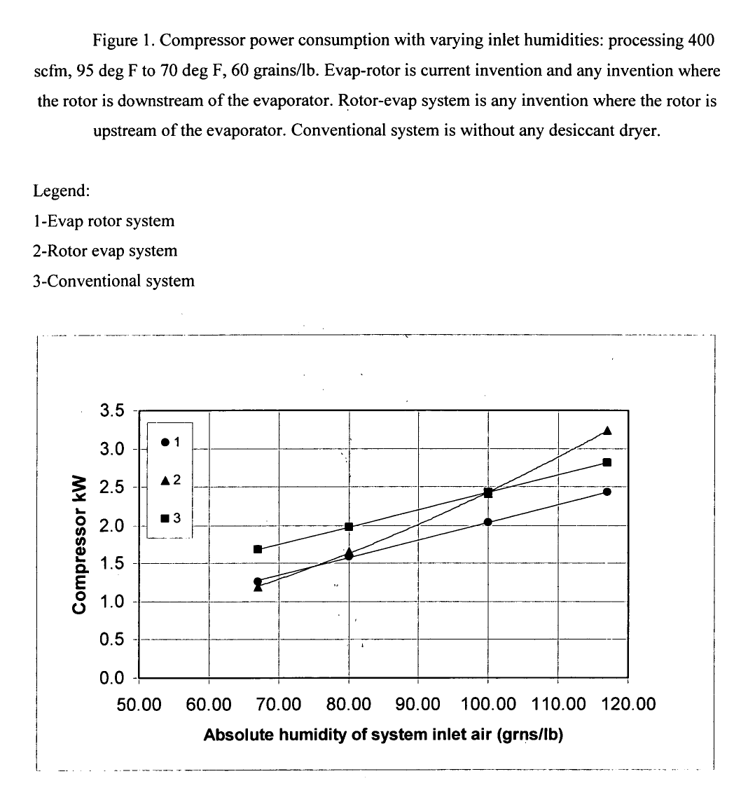

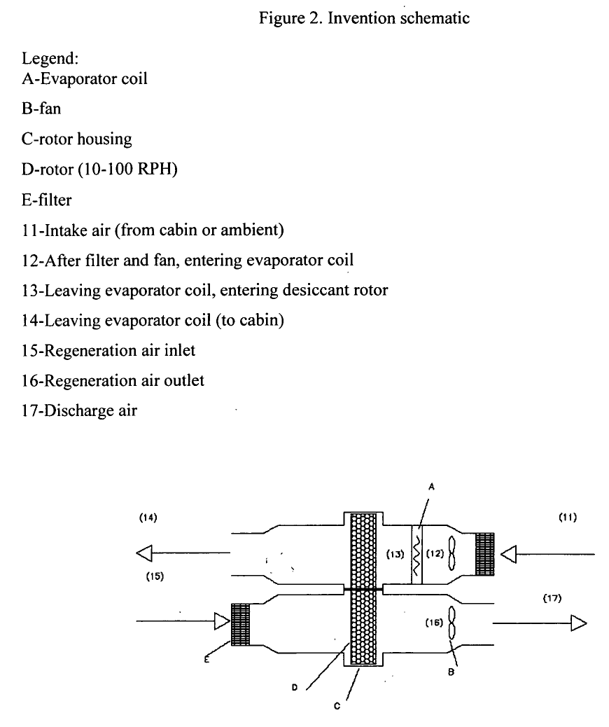

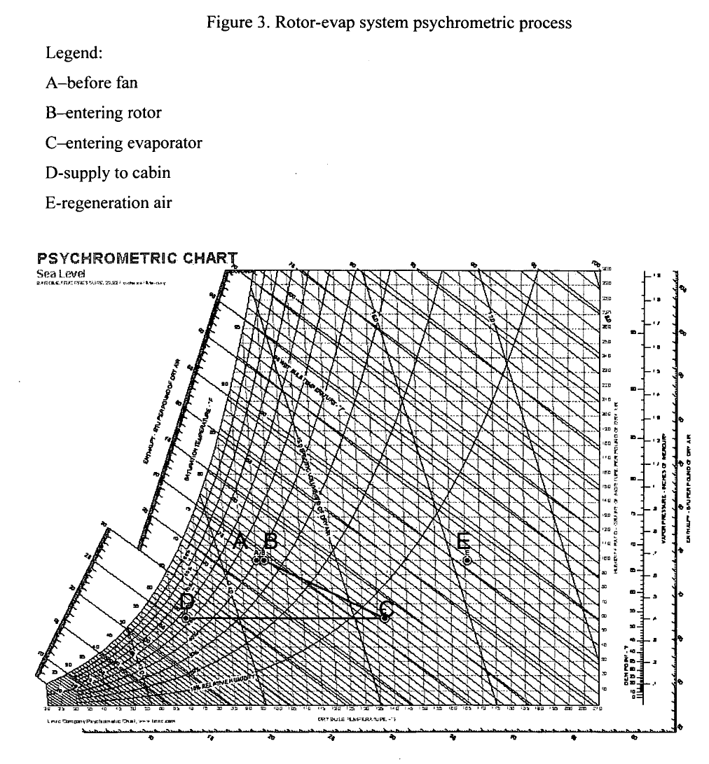

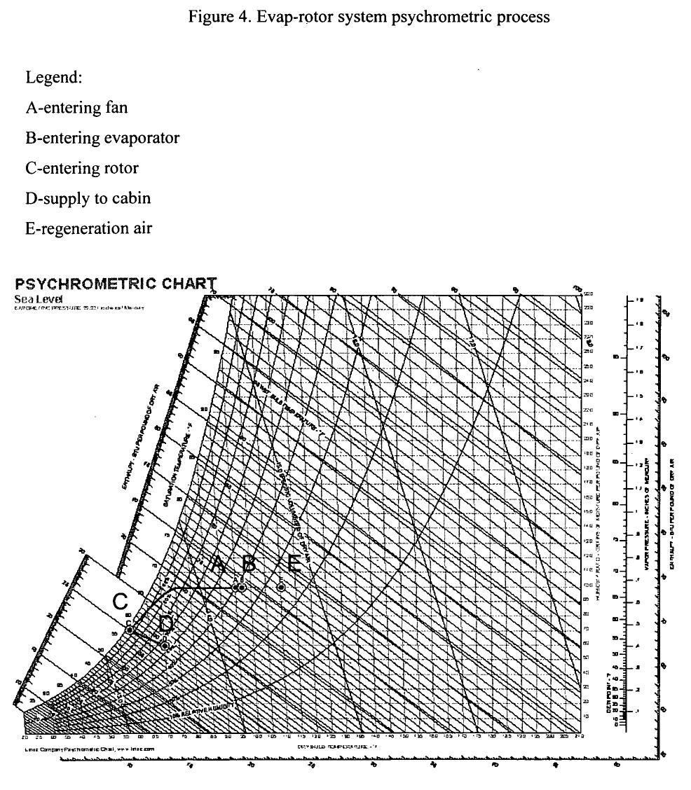

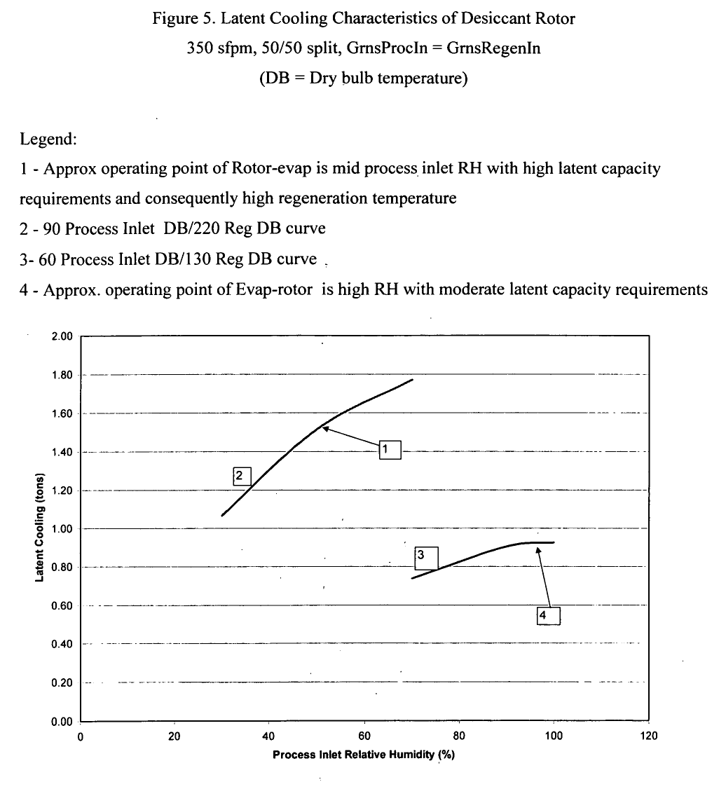

FIG. 2 is an illustration of the configuration of the invention where the desiccant rotor is downstream of the evaporator coil. The air being processed passes through the filter, the fan, and the evaporator coil where the air is cooled and dehumidified, then through the desiccant rotor where the air is dried and heated.

An analysis was performed on the configuration of this invention (evap-rotor) vs. a configuration where the desiccant is placed upstream of the evaporator (rotor-evap).

A model developed by Chant and Jeter (1995) for rotary desiccant wheels was used to simulate the desiccant rotor. In addition to the validation performed on the model described in the paper, the model was adapted to the Engelhard HexCore rotor and validated with data collected at the National Renewable Energy Laboratory in 1998. The model's latent capacity predictions for HexCore's hexagonal passage, Nomex core coated with titanium silicate desiccant were within +/−10% and the outlet dry bulb agreement followed the latent agreement. The model was used in the HexCore selection software until Engelhard Corporation closed the HexCore business in 2001. Since then, the model has been adapted by NovelAire technologies for design work and eventual integration into their selection software for their wound silica gel and molecular sieve series desiccant rotors. The model's predictions for Novelaire's rotor were also validated with NREL data and gave agreement of latent capacity errors between +/−10%. The NREL data is confidential.

Two rotor-evaporator coil configurations were under study. For each system, the rotor type, size and operating conditions were selected. These design selections are merely typical operating conditions for commercial desiccant wheels, with no optimization involved. The source of regeneration air is not addressed.

For the performance calculations included in this report, the inlet air state was constant at 95 deg F., while the inlet humidity was varied (117, 100, 80, and 67 grns/lb). For each of the four inlet humidities considered, the integrated systems were operated to supply 70 deg F., 60 grns/lb air to the cabin. The vapor compression system's capacity and the desiccant rotor's regeneration temperature and wheel speed were varied to produce the desired supply condition. Thus the performance calculations were performed for a constant sensible load and varying latent load. This approach was used in order to produce some parametric results with which to demonstrate the systems' characteristics.

In the case of the Rotor-evap system, the rotor was operated to remove the entire latent load, while the DX system performed only the sensible cooling. Thus the latent and sensible loads are handled independently. The VC system must remove the original sensible load plus the heat of adsorption. For Case 1—where the ambient humidity is 1117 grns/lb—this sensible load on the DX system is greater than the conventional system load and DX system tonnage required is more than the conventional system. Thus the Rotor-evap system will result in increased power consumption during periods of high humidity. Note that this is a typical summer operating condition for many regions of the United States, such as the entire East Coast and much of the Midwest. FIG. 3 shows a psychrometric plot for the rotor-evap system.

The rotor in the Evap-rotor system serves to handle a portion of the latent load, heating the air in the process and eliminating the need for reheat. The desiccant rotor's capacity increases with process inlet relative humidity, so the desiccant rotor's performance is well served by this configuration. The VC system was operated in each case to bring the air to a 58.5 deg F. dew point. The desiccant rotor's capacity was roughly constant since it was bringing the air from 58.5 deg F., 71 grns/lb to 70 deg F., 60 grns/lb. FIG. 4 shows a psychrometric plot for the rotor-evap system.

A rotor comprised of silica gel desiccant in a high temperature fiber substrate, was simulated. The rotor is 12 inches in diameter, and 4 (Evap-rotor system) or 6 (Rotor-evap system) inches deep. The wheel's rotation speed is between 12 and 45 revs/hour. A 50/50 face split, balanced flow design was used. The particular rotor simulated, excluding the housing, is estimated to be 2 to 3 lbs. However, there are similarly performing, light-weight rotors that could be evaluated for this application which would weigh about 1 lb. The regeneration temperature ranged from 110 to 205 deg F. In an actual installed system, these parameters would not be varied, but set at design time to handle a pre-defined extreme load. The system components would then be cycled as needed during part-load conditions.

Evaporator performance was estimated based on “typical” cooling coil performance. Latent cooling was initiated at about 80% RH.

The latent capacity (amount of dehumidification cooling performed) characteristics of a desiccant rotor as a function of regeneration temperature and relative humidity are shown in FIG. 5. FIG. 5 shows that the latent capacity of the rotor increases with increasing regeneration temperature and increasing process inlet relative humidity. For the system where the rotor is upstream of the evaporator, the rotor will need high capacity (in order to handle the entire latent load) and will be processing air at moderate relative humidities. Thus such a system, using thermal reactivation, requires regeneration temperature in the range of 220 deg F. This quality of thermal energy is only available from the engine's exhaust air. In the case of the system where the rotor is downstream of the evaporator and only handling a portion of the latent load, the rotor requires only moderate capacity and—since it is downstream of the evaporator—is processing nearly saturated air.

Thus results of the analysis completed so far have shown that the current invention is a good match with the low grade, safe thermal energy available from the engine coolant and radiator exhaust air. The results also indicate that compressor power consumption reduction is higher and more uniform when the desiccant dryer is placed after the evaporating coil.

1. An air-conditioning system for a cabin of a motorized vehicle comprising of an evaporator and desiccant, where said desiccant is downstream of evaporator, and said desiccant is a rotor that uses vehicle's excess heat to regenerate the desiccant.

2. An A/C system as set forth in claim 1 wherein the source of regeneration heat for the desiccant is hot air coming off the radiator that is routed into the rotor housing.

3. An A/C system as set forth in claim 1 wherein the source of regeneration heat for the desiccant is engine coolant exiting the engine block that is routed to a liquid-to-air heat exchanger to heat the regeneration air prior to entering the radiator.

4. An A/C system as set forth in claim 1 wherein the source of regeneration is hot engine exhaust, which after catalytic conversion which is routed to an air-to-air heat exchanger.

5. An A/C system as set forth in claim 1 wherein the source of regeneration is excess heat generated by a fuel cell.

6. A method of air-conditioning for a cabin of a motorized vehicle comprising of an evaporator and desiccant, where said desiccant is downstream of evaporator, and said desiccant is a rotor that uses vehicle's excess heat to regenerate the desiccant.
